(19) United States
(12) Patent Application Publication
(10) Pub. No.: US 2011/0315773 A1
(43) Pub. Date: Dec. 29, 2011

(54) METHOD AND APPARATUS FOR POWERING HANDHELD DATA CAPTURE DEVICES

(75) Inventors: Bradley S. Carlson, Huntington, NY (US); Duanfeng He, South Setauket, NY (US); Eugene Joseph, Coram, NY (US)

(73) Assignee: Symbol Technologies, Inc., Schaumburg, IL (US)

(21) Appl. No.: 12/824,342

(22) Filed: Jun. 28, 2010

(51) Int. Cl. G06K 7/10

(52) U.S. Cl. 235/462.41; 320/162; 320/166

(57) ABSTRACT

A method and apparatus for powering a handheld device. The method includes measuring a current withdrawn by the handheld device from a USB port of the handheld device. The handheld device can include a barcode reading arrangement for reading a barcode on a target object. The method also includes withdrawing a supplementary current from an energy storage element in the handheld device if the current withdrawn from the USB port reaches a threshold current value.

### FIELD OF THE DISCLOSURE

The present disclosure relates generally to handheld data capture devices including handheld barcode readers or handheld RFID readers.

### BACKGROUND

Various electro-optical systems have been developed for reading optical indicia, such as barcodes. A barcode is a coded pattern of graphical indicia comprised of a series of bars and spaces of varying widths. In a barcode, the bars and spaces having differing light reflecting characteristics. Some of the barcodes have a one-dimensional structure in which bars and spaces are spaced apart in one direction to form a row of patterns. Examples of one-dimensional barcodes include Uniform Product Code (UPC), which is typically used in retail store sales. Some of the barcodes have a two-dimensional structure in which multiple rows of bar and space patterns are vertically stacked to form a single barcode. Examples of two-dimensional barcodes include Code 49 and PDF417, which are respectively described in U.S. Pat. No. 4,794,239 and U.S. Pat. No. 5,304,786.

Systems that use one or more solid-state imagers for reading and decoding barcodes are typically referred to as imaging-based barcode readers, imaging scanners, or imaging readers. A solid-state imager generally includes a plurality of photosensitive elements or pixels aligned in one or more arrays. Examples of solid-state imagers include charged coupled devices (CCD) or complementary metal oxide semiconductor (CMOS) imaging chips.

FIG. 1 shows an imaging scanner 50 in accordance with some embodiments. The imaging scanner 50 has a window 56 and a housing 58 with a handle. The imaging scanner 50 also has a base 52 for supporting itself on a countertop. The imaging scanner 50 can be used in a hands-free mode as a stationary workstation when it is placed on the countertop. The imaging scanner 50 can also be used in a handheld mode when it is picked up off the countertop and held in an operator's hand. In the hands-free mode, products can be slid, swiped past, or presented to the window 56. In the handheld mode, the imaging scanner 50 can be moved towards a barcode on a product, and a trigger 54 can be manually depressed to initiate imaging of the barcode. In some implementations, the base 52 can be omitted, and the housing 58 can also be in other shapes.

In FIG. 1, a cable 59 is also connected to the base 52. The cable 59 can be implemented to provide the power to the imaging scanner 50. For variety of reasons, it is desirable to provide the power to the imaging scanner 50 with an USB (Universal Serial Bus) cable. But, in some implementations, the peak current requirement of the imaging scanner 50 can exceed the current limit imposed by the USB standard. For example, USB 2.0 allows a maximum load current of 500 mA, and USB 3.0 allows a maximum load current of 900 mA. In some of the existing implementations of the imaging scanner 50, special circuitry and methods have been developed to manage the peak current requirement of the imaging scanner 50 to make sure that the peak current does not exceed the limit imposed by the USB standard. In these implementations, because the system manages the peak current, it is not always operating at its full capability. Therefore, it may be desirable to find a technique that enables the imaging scanner 50 to operate at its full capability even if its peak current requirement sometimes exceeds the current limit imposed by the USB standard.

### SUMMARY

In one aspect, the invention is directed to a method. The method includes measuring a current withdrawn by a handheld device from a USB port of the handheld device. The handheld device can include a barcode reading arrangement for reading a barcode on a target object. The method also includes withdrawing a supplementary current from an energy storage element in the handheld device if the current withdrawn from the USB port reaches a threshold current value.

Implementations of the invention can include one or more of the following advantages. When a handheld device such as an imaging scanner is powered from an USB port, implementations of the invention can enable the handheld device to operate at its full capability even if its peak current requirement sometimes exceeds the current limit of the USB port. These and other advantages of the present invention will become apparent to those skilled in the art upon a reading of the following specification of the invention and a study of the several figures of the drawings.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 shows an imaging scanner in accordance with some embodiments.

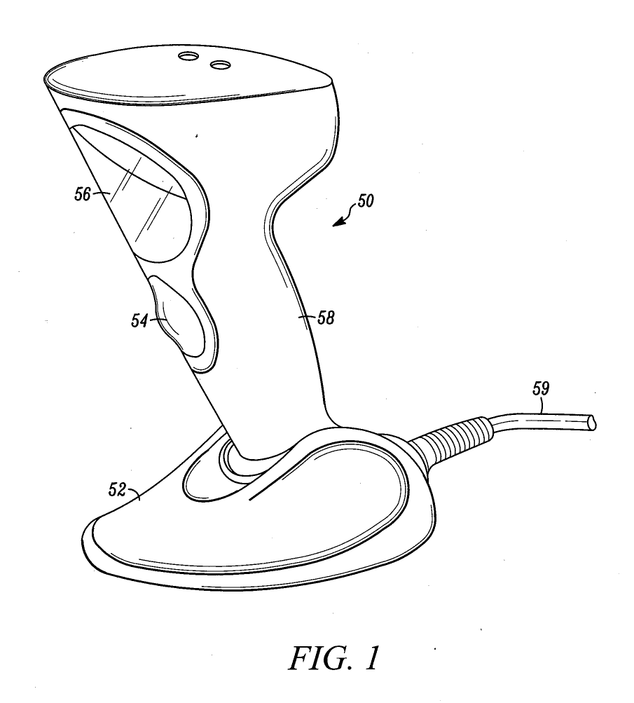

FIG. 2 is a schematic of an imaging scanner in accordance with some embodiments.

FIG. 3 depicts a handheld device having a barcode reading arrangement in accordance with some embodiments.

FIG. 4 is a flowchart of a method of powering a handheld device with a USB port in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

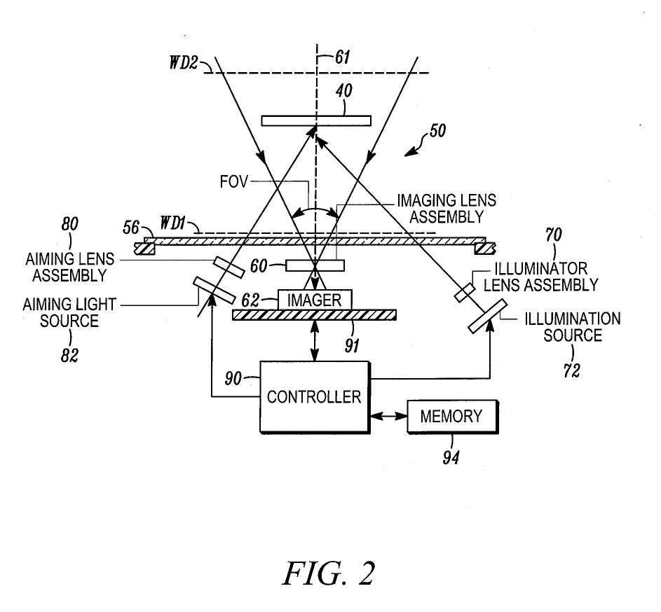

FIG. 2 is a schematic of an imaging scanner 50 in accordance with some embodiments. The imaging scanner 50 in FIG. 2 includes the following components: (1) a solid-state imager 62 positioned behind an imaging lens assembly 60; (2) an illuminating lens assembly 70 positioned in front of an illumination source 72; (3) an aiming lens assembly 80 positioned in front of an aiming light source 82; and (4) a controller 90. In FIG. 2, the imaging lens assembly 60, the illuminating lens assembly 70, and the aiming lens assembly 80 are positioned behind the window 56. The solid-state imager 62 is mounted on a printed circuit board 91 in the imaging scanner.

The solid-state imager 62 can be a CCD or a CMOS imaging device. The solid-state imager 62 generally includes multiple pixel elements. These multiple pixel elements can be formed by a one-dimensional array of photosensitive elements arranged linearly in a single row. These multiple pixel elements can also be formed by a two-dimensional array of photosensitive elements arranged in mutually orthogonal rows and columns. The solid-state imager 62 is operative to detect light captured by an imaging lens assembly 60 along an optical path or axis 61 through the window 56. Generally, the solid-state imager 62 and the imaging lens assembly 60 are designed to operate together for capturing light scattered or reflected from a barcode 40 as pixel data over a two-dimensional field of view (FOV).

The barcode 40 generally can be located anywhere in a working range of distances between a close-in working distance (WD1) and a far-out working distance (WD2). In one specific implementation, WD1 is about a few inches from the window 56, and WD2 is about a few feet from the window 56. Some of the imaging scanners can include a range finding system for measuring the distance between the barcode 40 and the imaging lens assembly 60. Some of the imaging scanners can include an auto-focus system to enable a barcode be more clearly imaged with the solid-state imager 62 based on the measured distance of this barcode. In some implementations of the auto-focus system, the focus length of the imaging lens assembly 60 is adjusted based on the measured distance of the barcode. In some other implementations of the auto-focus system, the distance between the imaging lens assembly 60 and the solid-state imager 62 is adjusted based on the measured distance of the barcode.

In FIG. 2, the illuminating lens assembly 70 and the illumination source 72 are designed to operate together for generating an illuminating light towards the barcode 40 during an illumination time period. The illumination source 72 can include one or more light emitting diodes (LED). The illumination source 72 can also include a laser or other kind of light sources. The aiming lens assembly 80 and the aiming light source 82 are designed to operate together for generating a visible aiming light pattern towards the barcode 40. Such aiming pattern can be used by the operator to accurately aim the imaging scanner at the barcode. The aiming light source 82 can include one or more light emitting diodes (LED). The aiming light source 82 can also include a laser or other kind of light sources.

In FIG. 2, the controller 90, such as a microprocessor, is operatively connected to the solid-state imager 62, the illumination source 72, and the aiming light source 82 for controlling the operation of these components. The controller 90 can also be used to control other devices in the imaging scanner. The imaging scanner 50 includes a memory 94 that can be accessible by the controller 90 for storing and retrieving data. In many embodiments, the controller 90 also includes a decoder for decoding one or more barcodes that are within the field of view (FOV) of the imaging scanner 50. In some implementations, the barcode 40 can be decoded by digitally processing a captured image of the barcode with a microprocessor.

In operation, in accordance with some embodiments, the controller 90 sends a command signal to energize the illumination source 72 for a predetermined illumination time period. The controller 90 then exposes the solid-state imager 62 to capture an image of the barcode 40. The captured image of the barcode 40 is transferred to the controller 90 as pixel data. Such pixel data is digitally processed by the decoder in the controller 90 to decode the barcode. The information obtained from decoding the barcode 40 is then stored in the memory 94 or sent to other devices for further processing.

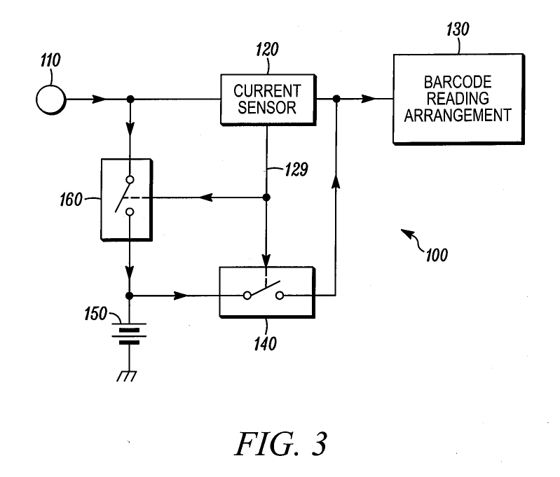

FIG. 3 depicts a handheld device 100 having a barcode reading arrangement 130 in accordance with some embodiments. The handheld device 100 includes a USB port 110, a current sensor 120, an externally controllable switch 140, an energy storage element 150, an externally controllable switch 160, and the barcode reading arrangement 130 for reading a barcode 40 on a target object. In one implementation, the barcode reading arrangement 130 includes the solid-state imager 62 having an array of photosensitive elements, the illumination source 72, and the controller 90, which are parts of the imaging scanner 50 in FIG. 2. In other implementations, the barcode reading arrangement 130 can also includes an electric circuitry operative to transfer the image captured by the solid-state imager to a decoding circuitry. In addition, the barcode reading arrangement 130 may also include the illuminating lens assembly 70 or the aiming lens assembly 80.

In FIG. 3, the barcode reading arrangement 130 is generally powered by the current supplied by the USB port 110. In the event that the current required by the barcode reading arrangement 130 is larger than the maximum current that can be withdrawn from the USB port 110, the energy storage element 150 such as a battery or a very large capacitor can provide a supplementary current to the handheld device to make up the difference. In some implementations, the energy storage element 150 is used to provide the supplementary current when the current required by the barcode reading arrangement 130 reaches 99% of the maximum current that can be withdrawn from the USB port 110. Alternatively, the supplementary current can be provided when the required current reaches 90%, 95%, or 98% of that maximum current.

In one implementation as shown in FIG. 3, a current sensor 120 is used for measuring a current withdrawn by the handheld device from the USB port 110. The current withdrawn from the USB port can be mostly used for providing the power for barcode reading arrangement 130, as shown in FIG. 3. But the current withdrawn may also be used to power other components in the handheld device. In one implementation, an output 129 from the current sensor 120 is used to control the externally controllable switch 140. The externally controllable switch 140 can be configured to change its conducting state based on a comparison between a threshold current value and the current withdrawn from the USB port as measured by the current sensor 120. If the current withdrawn from the USB port by the handheld device reaches a threshold current value, the externally controllable switch 140 changes to conducting state such that the supplementary current is provided to the handheld device from the energy storage element 150. In alternative implementations, the externally controllable switch 140 can be replaced with three terminal devices functioning as variable resistors.

Generally, if the current required by the handheld device is less than the maximum current that can be withdrawn from the USB port 110, it is possible to use such additional capacity to charge the energy storage element 150. For example, in the implementation as shown in FIG. 3, the output 129 from the current sensor 120 is used to control the externally controllable switch 160. The externally controllable switch 160 can be configured to change its conducting state based on a comparison between a threshold current value and the current withdrawn from the USB port as measured by the current sensor 120. If the current withdrawn from the USB port by the handheld device is less than the threshold current value, the externally controllable switch 160 changes to conducting state such that the energy storage element 150 can be charged with the current from the USB port 110. The threshold current value for controlling the externally controllable switch 160 can be the same as the threshold current value for controlling the externally controllable switch 140; but, in some implementations, these two threshold current values can also be different.

In the implementation as shown in FIG. 3, the USB port 110 and the energy storage element 150 are used to power the barcode reading arrangement 130. In other implementations, the USB port 110 and the energy storage element 150 in the electric circuit similar to that in FIG. 3 can also be used to power an RFID reader in handheld devices.

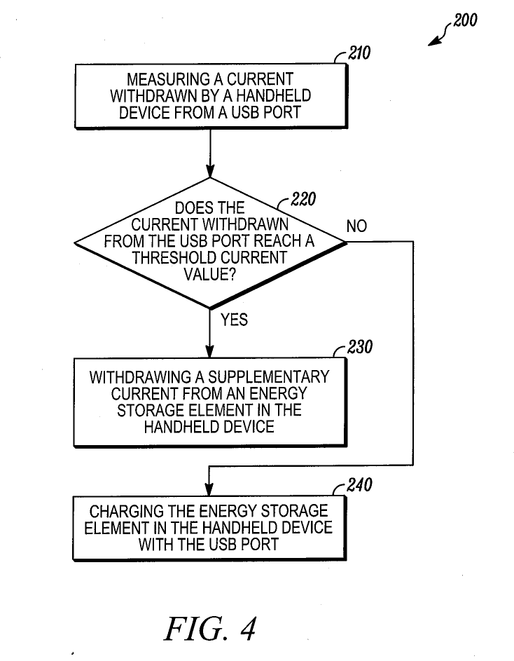

FIG. 4 is a flowchart of a method 200 of powering a handheld device with a USB port in accordance with some embodiments. The method 200 includes blocks 220, 230, and 240. At block 210, a current withdrawn by a handheld device from a USB port is measured. Subsequently, at block 220, the current withdrawn from the USB port is compared with a threshold current value. If the current withdrawn from the USB port reaches the threshold current value, at block 230, a supplementary current is withdrawn from an energy storage element in the handheld device. On the other hand, if the current withdrawn from the USB port is less than the threshold current value, at block 240, the energy storage element can be charged by the current from the USB port. In some implementations, even if the current withdrawn from the USB port is less than the threshold current value, additional condition can be implemented before the energy storage element is charged by the current from the USB port. This additional condition may involve a comparison of the current withdrawn from the USB port with another but different threshold current value. This additional condition may involve a measurement on whether the energy storage element is fully charged.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof; are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
measuring a current withdrawn by a handheld device from a USB port of the handheld device, the handheld device including a barcode reading arrangement for reading a barcode on a target object; and
withdrawing a supplementary current from an energy storage element in the handheld device if the current withdrawn from the USB port reaches a threshold current value.

2. The method of claim 1, further comprising:
charging the energy storage element in the handheld device with the USB port if the current withdrawn from the USB port is less than the threshold current value.

3. The method of claim 1, wherein the energy storage element is a battery.

4. The method of claim 1, wherein the energy storage element is a capacitive element.

5. The method of claim 1, further comprising:
selecting the threshold current value to be a value between 90% to 100% of a maximum current value specified for the USB port.

6. The method of claim 5, wherein the maximum current value is one of 500 mA and 900 mA.

7. The method of claim 1, further comprising:
selecting the threshold current value to be a value between 95% to 100% of a maximum current value specified for the USB port.

8. The method of claim 1, further comprising:
selecting the threshold current value to be a value between 98% to 100% of a maximum current value specified for the USB port.

9. The method of claim 1, wherein the barcode reading arrangement comprises:
a solid-state imager having an array of photosensitive elements for capturing an image having the barcode;
a lens system operative to focus light reflected from the target object onto the array of photosensitive elements in the solid-state imager; and
an electric circuitry operative to transfer the image captured by the solid-state imager to a decoding circuitry.

10. The method of claim 1, wherein the barcode reading arrangement comprises a solid-state imager having an array of photosensitive, an illumination source, and a controller.

11. The method of claim 1, wherein the handheld device further comprises an RFID reader.

12. An apparatus comprising:
a handheld device including at least one of a barcode reading arrangement and an RFID reader
a USB port;
a current sensor for measuring a current withdrawn by the handheld device from of the USB port; and
an energy storage element configured to supply a supplementary current to the handheld device if the current withdrawn from the USB port by the handheld device reaches a threshold current value.

13. The apparatus of claim 12, wherein the energy storage element is a battery.

14. The apparatus of claim 12, wherein the energy storage element is a capacitive element.

15. The apparatus of claim 12, wherein the threshold current value is set to be between 90% to 100% of a maximum current value specified for the USB port.

16. The apparatus of claim 12, wherein the threshold current value is set to be between 95% to 100% of a maximum current value specified for the USB port.

17. The apparatus of claim 12, wherein the threshold current value is set to be between 98% to 100% of a maximum current value specified for the USB port.

18. The apparatus of claim 12, wherein the barcode reading arrangement comprises:
a solid-state imager having an array of photosensitive elements for capturing an image from a target object having a barcode;
a lens system operative to focus light reflected from the target object onto the array of photosensitive elements in the solid-state imager; and
an electric circuitry operative to transfer the image captured by the solid-state imager to a decoding circuitry.

19. A method comprising:
withdrawing a current by a handheld device from a USB port of the handheld device, the handheld device including at least one of a barcode reading arrangement for reading a barcode on a target object and an RFID reader for reading an RFID tag;
withdrawing a supplementary current from an energy storage element in the handheld device if the current withdrawn from the USB port is larger than a threshold current value.

20. The method of claim 19, further comprising:
charging the energy storage element in the handheld device with the USB port if the current needed by the handheld device is less than the threshold current value.
